(19) United States
(12) Patent Application Publication
(10) Pub. No.: US 2009/0202692 A1
(43) Pub. Date: Aug. 13, 2009

(54) Seasoning dispenser

(76) Inventor: Sang Hoon Chun, Alpharetta, GA (US)

Correspondence Address: RYNDAK & SURI LLP, 200 W. MADISON STREET, SUITE 2100, CHICAGO, IL, 60606, US

(21) Appl. No.: 12/069,535

(22) Filed: Feb. 11, 2008

(51) Int. Cl. A23L 1/22; A47G 19/24; A47G 19/30

(52) U.S. Cl. 426/442; 222/142.1; 222/565

(57) ABSTRACT

A seasoning dispenser is provided having a container for containing a quantity of a seasoning mixture, preferably salt and pepper particles and an anti-streaming agent. The dispenser has an upper chamber in communication with a lower chamber. The upper chamber is used for storing a bulk quantity of seasoning mixture. The lower chamber dispenses the seasoning mixture through at least one opening. The lower chamber has a headspace. A method of using the seasoning dispenser is provided where the dispenser is moved up and down over a food item.

### TECHNICAL FIELD

The present invention relates to a seasoning dispenser, and more particularly to a salt and pepper dispenser having an anti-streaming agent and a container with openings that are larger than the salt and pepper particles.

### BACKGROUND OF THE INVENTION

Effectively seasoning meat and other patties while they are cooking on a grill can be a daunting task. Dispensers exist that dispense both salt and pepper and other seasonings. However, the dispensers require a user to shake or otherwise agitate them in order for the salt and pepper contained within to exit. Shaking or agitating the containers usually results in widely varying amounts of seasoning, depending on how the user shakes the dispenser. In addition, an uncontrolled amount of seasoning may discharge out of existing containers if the dispenser has flexible side walls and the user squeezes the sidewalls. This can be problematic when seasoning patties while they are cooking on a grill because each patty can be differently seasoned or the same patty can have varying amounts of seasoning in different areas. Uneven and inconsistent seasoning can wreak havoc with customers with discriminating tastes because the taste of the patty and resulting sandwich as a whole can be disturbed.

A need exists for a salt and pepper dispenser that provides for a consistent and uniform amount of seasoning. A need also exists for a salt and pepper dispenser that evenly distributes a consistent amount of seasoning over the entire diameter of a circular patty. A need also exists for a salt and pepper dispenser that improves burger and fillet sandwiches because it consistently delivers a well-seasoned patty from the first bite to the last.

Current salt and pepper dispensers have holes on top of a container. To dispense the salt and pepper, a user must first invert the container so the holes are in a down position. However, the user must be cautious and not hold the container in the holes-down position for too long because the salt and pepper inside the container will stream out in an uncontrolled manner, and the excessive amount of salt and pepper would disrupt the taste of the patty. To apply seasoning, a user must quickly invert and shake the dispenser in order to dispense a desired amount of salt and pepper. This method of seasoning is a procedure that requires a degree of skill, manual dexterity and practice and can take a long time to effectively master. In addition to the likelihood that each individual patty has a relatively high probability of becoming inconsistently and non-uniformly seasoned, with existing dispensers, there is also a risk that salt and pepper will be wasted because it will go beyond the perimeter of the patty and into the grill area. A need exists for a simple and easy to learn method of effectively and evenly seasoning a meat patty or other patty while grilling. A need also exists for a salt and pepper dispenser that eliminates wasted salt and pepper.

### SUMMARY OF THE INVENTION

In accordance with one aspect of the present invention, a seasoning shaker dispenser for containing and dispensing a quantity of a particulate seasoning is provided. The dispenser has (1) an upper chamber for containing a bulk quantity of the particulate seasoning and (2) a lower chamber in communication with the upper chamber for containing a generally constant quantity of the particulate seasoning. The lower chamber has at least one opening extending from the lower chamber to the exterior of the container for dispensing the particulate seasoning from the lower chamber in a relatively small quantity compared to the quantity of seasoning contained in the lower chamber in response to a single up-and-down shake of the container. The particulate seasoning may comprise salt, pepper and preferably an anti-streaming agent, which may be an oil.

In accordance with another aspect of the present invention, a seasoning shaker dispenser for containing and dispensing a quantity of a particulate seasoning is provided. The dispenser has a container having a primary chamber and a secondary chamber. The primary chamber is located above the secondary chamber. The primary chamber is for containing a bulk quantity of the particulate seasoning. The secondary chamber has at least one opening for dispensing a relatively uniform discrete amount of the particulate seasoning from the secondary chamber of the container in response to a single up-and-down shake of the container. The seasoning shaker dispenser has a partitioning member for dividing the container into the primary and secondary chambers and for permitting seasoning mixture to enter the secondary chamber from the primary chamber. The partitioning member is adapted to prevent the seasoning mixture received from the primary chamber from completely filling the secondary chamber.

In accordance with still another aspect of the present invention, a method of seasoning a food item is provided. The method includes providing a dispenser. The dispenser has an upper chamber for containing a bulk quantity of the particulate seasoning and a lower chamber. The lower chamber is in communication with the upper chamber. The lower chamber is for containing a generally constant quantity of the particulate seasoning. The lower chamber has at least one opening extending from the lower chamber to the exterior of the container for dispensing the particulate seasoning from the lower chamber in a relatively small quantity compared to the quantity of seasoning contained in the lower chamber in response to a single up-and-down shake of the container.

The method includes storing a seasoning mixture in the dispenser, and vertically moving the container up and down directly over an item of food to be seasoned to distribute the stored seasoning mixture into a dispensing chamber and to dispense a controlled quantity of the mixture onto the food item from the lower chamber.

In accordance with yet another aspect of the present invention, a method of seasoning a food item is provided. The method includes providing a dispenser. The dispenser has a container having a primary chamber and a secondary chamber. The primary chamber is located above the secondary chamber and is for containing a bulk quantity of the particulate seasoning. The secondary chamber has at least one opening for dispensing a relatively uniform discrete amount of the particulate seasoning from the secondary chamber of the container in response to a single up-and-down shake of the container. The dispenser has a partitioning member for dividing the container into the primary and secondary chambers and for permitting seasoning mixture to enter the secondary chamber from the primary chamber. The partitioning member is adapted to prevent the seasoning mixture received from the primary chamber from completely filling the secondary chamber.

The method includes (1) storing in the primary chamber a seasoning mixture having particles that can fit through the at least one opening, (2) distributing the stored seasoning mixture into the secondary chamber, and (3) vertically moving the dispenser up and down directly over an item of food to dispense a controlled quantity of the seasoning mixture onto the food item from the secondary chamber, the quantity being substantially less than the amount of seasoning mixture in the secondary chamber.

Numerous advantages may be realized by the present invention. The dispenser provides a substantially uniform amount of seasoning. This amount of seasoning can be calibrated so that the seasoning of food items can be achieved quickly without risking the under- or over-seasoning of the food items. In addition, the dispenser provides a substantially uniform amount of seasoning over a large range of fill levels and that is independent or substantially independent of the amount of seasoning contained in the dispensing device. Consequently, as the amount of seasoning contained in the dispensing device is depleted, the amount dispensed remains relatively constant. The uniform amount of seasoning mixture ultimately improves the taste of the food item because it consistently delivers a predetermined and uniform amount of seasoning to a food item. In addition, because the dispenser requires only a single up-and-down motion rather than, for example, turning a dispenser upside down and then right side up, the seasoning can be more accurately and more rapidly distributed onto a food item. The dispenser can be stored at grill level, making it easier for the user to use.

### BRIEF DESCRIPTION OF THE DRAWINGS

FIG. 1 illustrates a perspective view of a device in accordance with the present invention;

FIG. 2 illustrates an exploded view of the device of FIG. 1;

FIG. 3 illustrates a sectional view of the device of FIG. 1;

FIG. 4 illustrates a plan view of a cover usable with the device of FIG. 1;

FIG. 5 illustrates a patty to be seasoned;

FIG. 6 illustrates a method of seasoning a food item using the device of FIG. 1;

FIG. 7 illustrates a method of seasoning a group of food items using the device of FIG. 1;

FIG. 8 illustrates an enlarged view of salt and pepper particles used with the device of FIG. 1;

FIG. 9 illustrates the theoretical pattern of movement of seasoning within the device of FIG. 1;

FIG. 10 illustrates levels of seasoning in the device of FIG. 1; and

FIG. 11 compares the amount of dispense of the device of FIG. 1 to a prior art device.

### DETAILED DESCRIPTION OF THE INVENTION

In the description of the present invention, “streaming” will be understood to include an uncontrolled discharge of seasoning through an opening of a dispenser, i.e., the uncontrolled flowing of seasoning particles out of the dispenser from within the dispenser through discharge openings in the dispenser. Referring to the figures generally, there is illustrated a dispenser 10 in accordance with the invention. Dispenser 10 includes a container 12 having a first chamber 14 and a second or dispensing chamber 16. Dispenser 10 contains a quantity of a seasoning mixture 18. Dispenser 10 also includes a cover 20 having at least one opening 22 for dispensing seasoning mixture 18.

Container 12 has a cylindrical upper body portion 24 and a lower body portion 26. Upper body portion 24 is sized to be easily gripped by a person. As illustrated, lower body portion 26 is frustoconical, being wider at its bottom. Lower body portion 26 is threaded so that cover 20 can threadingly engage portion 26 and so that cover 20 can be removed for filling dispenser 10 with seasoning mixture 18.

First chamber 14 and second chamber 16 of container 12 communicate so that seasoning mixture 18 may flow between chambers 14 and 16. Preferably chambers 14 and 16 communicate by at least one passageway 28. As illustrated, partitioning member 30 separates first chamber 14 from second chamber 16. In an alternative embodiment, not illustrated, there may be a gap between partitioning member 30 and lower body portion 26 of container 12 allowing passageway 28 to pass around partitioning member 30.

Generally, first chamber 14 is substantially larger than second chamber 16. In effect, first chamber 14 is sized to store a sufficient quantity of seasoning mixture 18 to avoid frequent refilling of dispenser 10. However, first chamber 14 should not be so large that seasoning mixture 18 could go bad or spoil or so large as to cause a person to tire from using dispenser 10. In particular, first chamber 14 is sized to hold over 100 dispenses, preferably over 200 dispenses, more preferably over 400 dispenses, and most preferably over 800 dispenses. A dispense is the amount of seasoning dispensed for a single up-and-down movement of the dispenser in accordance with a method of using the dispenser, which will be discussed later. Seasoning mixture 18 is dispensed from second chamber 16.

Second chamber 16 is sized to prevent streaming. In particular, to prevent streaming the weight of seasoning mixture 18 in second chamber 16 must be sufficient to allow seasoning mixture 18 to bridge over openings 22. Preferably, second chamber 16 is sized to hold more than 10 dispenses, preferably more than 25 dispenses, and most preferably more than 50 dispenses.

However, it is also desirable to limit the size of second chamber 16 so that it is substantially smaller than first chamber 14. In this manner, the amount of seasoning mixture 18 in second chamber 16 remains generally constant even though the amount of seasoning mixture 18 in first chamber 14 varies significantly as seasoning mixture 18 is dispensed and first chamber 14 empties before being refilled. Generally second chamber 16 is sized to hold no more than 100 dispenses and preferably no more than 75 dispenses.

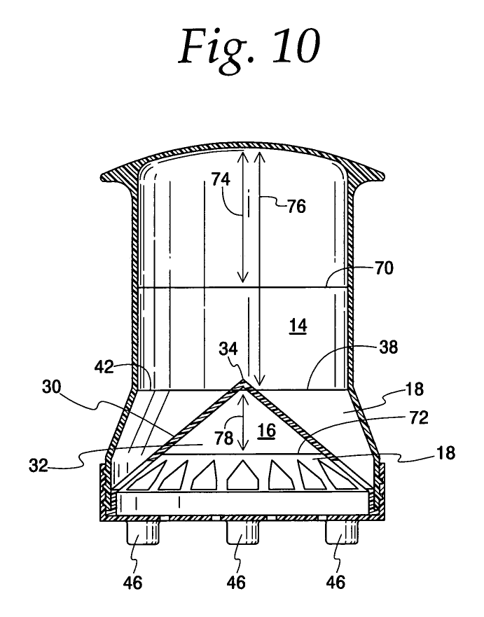

In addition, second chamber 16 is configured to maintain a headspace 32. Headspace 32 is a volume that is not filled with seasoning when dispenser 10 is at rest in a holes-down position as shown in FIG. 10. However, when dispenser 10 is shaken up and down, mixture 18 moves in and out of headspace 32 allowing mixture 18 to move up and down in second chamber 16. To have headspace 32, the top of chamber 16 is above the top of passageways 28, where passageways 28 enter chamber 16.

As illustrated, first chamber 14 is defined by container 12 and partitioning member 30 and second chamber 16 is defined by partitioning member 30 and cover 20. As illustrated, the shape of partitioning member 30 provides headspace 32. Typically, the top of second chamber 16 (partitioning member 30) is convex having an upper apex 34. It is contemplated that partitioning member 30 may be substantially conical, substantially hemispherical, substantially frusto-hemispherical, substantially frusto-conical, or combinations of these shapes. As illustrated, partitioning member 30 has a plurality of passageways 28 substantially at the bottom of partitioning member 30.

Preferably, various components of dispenser 10 are in a specific vertical alignment when dispenser 10 is an opening-down position. In particular, first chamber 14 is above partitioning member 30 which is above second chamber 16. In addition, passageways 28 preferably are substantially outside of the inner sidewalls of upper portion 24. The benefits of second chamber 16, partitioning member 30, and the discussed vertical alignment will be presented later.

Dispenser 10 may include a minimum fill level line 38. Minimum fill level line 38 indicates when dispenser 10 needs to be refilled with mixture 18. By maintaining an amount of mixture 18 that is at least up to minimum fill level line 38, dispenser 10 can properly deliver a correct amount of mixture 18 per food item F. Generally, minimum fill level line 38 should be above the top of passageways 28. The location of minimum fill level line 38 may include a substantial safety margin.

To refill dispenser 10, dispenser 10 may be inverted and placed on its top 40. Top 40 may be flat or concave, but is preferably convex with a radius of curvature allowing dispenser 10 to balance on its top to allow refilling but discouraging the storage of dispenser 10 in an inverted or openings-up position. Next, cover 20 is unthreaded and removed. Then partitioning member 30 is removed. Seasoning mixture 18 is then poured into first chamber 14 up to about refill line 42. As illustrated, refill line 42 and minimum level line 38 are the same.

Next partitioning member 30 is replaced. Seasoning mixture 18 may also be poured into second chamber 16. It has been found that if second chamber 16 is not prefilled or primed prior to initial use that dispenser 10 will tend to overdispense initially. Finally cover 20 can be threaded onto lower portion 26.

Dispenser 10 may have additional optional features. For example, dispenser 10 may have a textured upper body portion 24 so that dispenser 10 is easier to grip firmly. The texture may include raised ribs around upper body portion 24. In addition, top 40 may be wider than upper body portion 24 so as to prevent inadvertent contact between the hand holding dispenser 10 and other objects in the environment. Also, dispenser 10 may have feet 46.

Dispenser 10 is a simple and elegant solution for quickly applying uniform amounts of seasoning to food. Preferably, dispenser 10 lacks unnecessary structures such as valves and closing devices for blocking communication between first and second chambers 14 and 16.

Seasoning mixture 18 is comprised of seasoning particles. Seasoning particles can include any suitable food-safe seasoning. Preferably the seasoning particles are selected from the group of salt, spices and herbs. For example, it is contemplated that seasoning mixture 18 could be a mixture of Italian herbs, or cinnamon and nutmeg for spicing sweet items. In one embodiment, seasoning mixture 18 includes salt and pepper particles 50 and 52. The relative amounts of different seasonings in seasoning mixture 18 can be chosen as desired. For example, for a salt and pepper mixture, the mixture may be about 15-40% pepper and about 60-85% salt. Other relative amounts of salt and pepper and/or other seasonings can be used as desired.

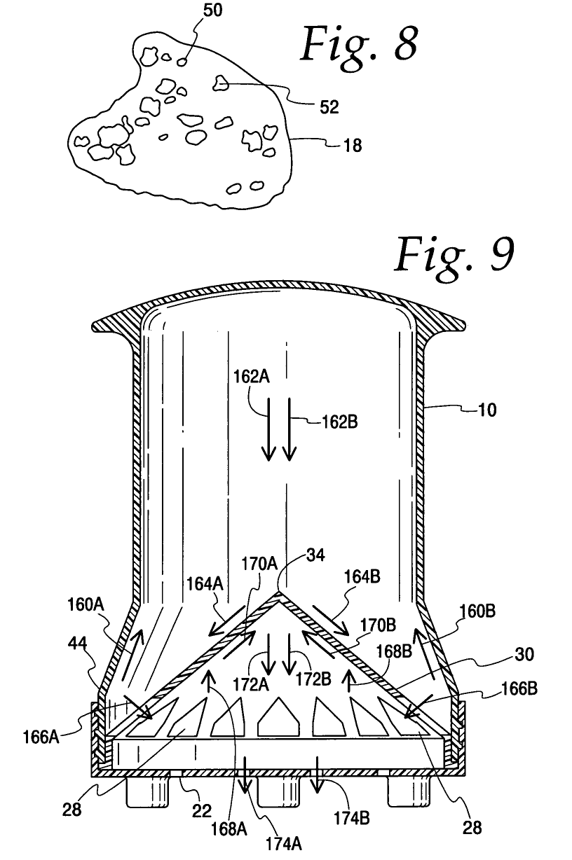

Seasoning particles can be any suitable size or shape. Suitable shapes include but are not limited to flake as illustrated in FIG. 8, spherical or irregular. For example, the salt can have a particle size of 0.5-2.0 mm, or 35% will be retained on a #35 U.S.S. screen and 30% maximum will pass through a #50 U.S.S screen. One particularly useful salt is sold under the trade name Cargill Premier Select Coarse Flake Salt by Cargill Salt of Minneapolis, Minn. That salt can have a specification of at most 35% retention on a #16 U.S.S. screen and 30% maximum will pass through a #50 U.S.S screen. A typical sieve analysis for salt is 15% retention on a #16 U.S.S. screen, 28% retention on a #20 U.S.S. screen, 22% retention on a #30 U.S.S. screen, 14% retention on a #40 U.S.S. screen, 10% retention on a #50 U.S.S. screen, and the balance being pan. Similarly, pepper can be at least 95% bigger than 1 mm, for example. As further examples, pepper or other seasoning particles can be 34 mesh particle size or greater, and can be sized so that 100% passes through a #20 U.S.S screen and at most 25% is retained on a #30 U.S.S. screen. The salt and pepper mixture can be sized so that a maximum of 34% is retained on a #35 U.S.S. screen or so that a maximum of 90% is retained on a #30 U.S.S. screen.

Seasoning mixture 18 may also include an anti-streaming agent. The anti-streaming agent is preferably present in an amount effective to prevent streaming of mixture 18 through openings 22 by gravity. The anti-streaming agent may also prevent the separation of seasonings in a seasoning mixture. The desirability and amount of anti-streaming agent is a function of a seasoning mixture tendency to stream out of dispenser 10 and to separate in dispenser 10. In some cases, anti-streaming agent may not be necessary. In the preferred embodiment, the anti-streaming agent includes an edible oil which may be flavored. The oil may also include an emulsifier such as monoglyceride, diglyceride or lecithin. While not wishing to be bound by theory, it is believed that the emulsifier helps the oil to wet the salt. The edible oil may be present in an amount of from about 0.5% to about 3.0% by total weight of mixture 18. In one embodiment, the anti-streaming agent is soybean oil. In another embodiment, the soybean oil is present in mixture 18 in an amount of from about 1.0% to about 2.5% by total weight of mixture 18. In a specific embodiment, the soybean oil is present in an amount of about 1.5% by weight of mixture 18. A suitable seasoning mixture is McCormick Grill Seasoning—FA7646. A suitable salt is Cargill Premier Select Coarse Flake Salt.

Seasoning mixture may have a loose bulk density of 56-68 lb/cu. ft, more preferably 58-66 lb/cu. ft, still more preferably 60-64 lb/cu. ft, and most preferably about 62 lb/cu. ft.

The dispense volume of a particular formulation of seasoning can be adjusted by increasing or decreasing the dispense hole quantity or changing the hole locations. Another method of adjustment is to increase or decrease the dispense hole size. Final adjustment can be made by the combinations of hole quantity, locations, and sizes.

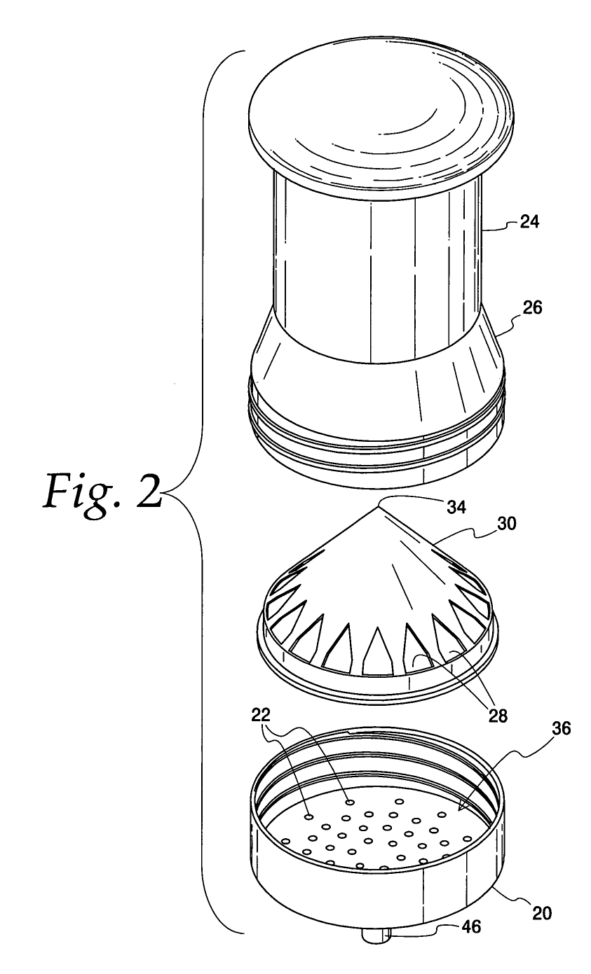

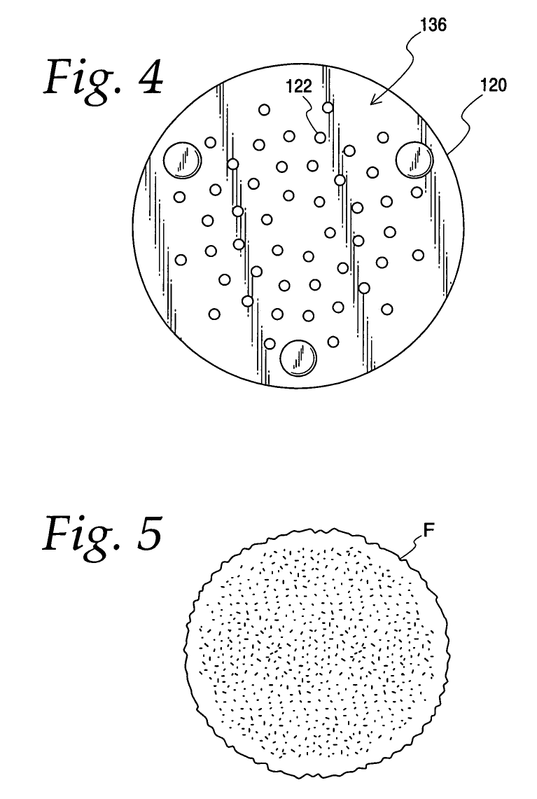

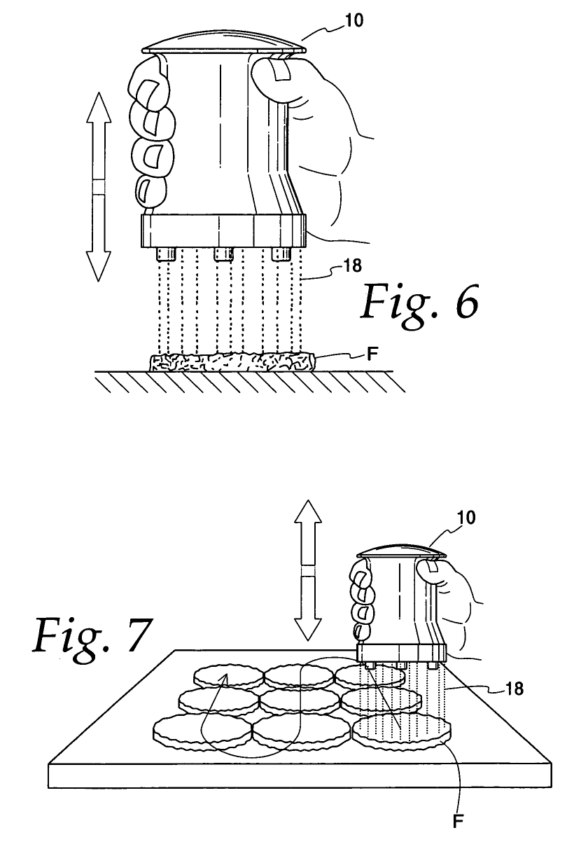

As illustrated in FIGS. 2 and 4, respectively, covers 20 and 120 are two embodiments of covers that may be used with dispenser 10. Covers 20 and 120 have arrays 36 and 136 of openings 22 and 122, respectively. Arrays 36 and 136, which have a diameter of about 2″ and 2.5″ respectively, each define an area that is smaller, generally about 10-25% smaller in area than the area of a food item F to be seasoned, as best illustrated in FIG. 6. Vertically moving dispenser 10 over food item F causes seasoning mixture 18 to be dispensed over substantially the entire area of food item F, at least about 75-90% of the area of food item F. The shape of array 36 is preferably substantially similar to the shape of the surface of food item F.

The size, location and number of openings 22 and 122 may be varied based on the flow characteristics of seasoning mixture 18 (for example, particle size), the desired quantity to be dispensed, and the area of food item F. However, openings 22 and 122 cannot be so large that seasoning mixture 18 streams through the holes and not so small that particles 50 and 52 cannot pass through. Preferably, openings 22 are larger in cross-sectional dimension than two salt and pepper particles 50 and 52. More preferably, the largest dimension of salt and pepper particles 50 and 52 is from about 0.25 to about 0.3 of the diameter of openings 22. The number of holes may vary in number between about 10 and about 100, preferably between about 15 and about 80, more preferably between about 20 and about 50.

Openings 22 may have a diameter that varies between about 1 mm and about 4.5 mm, preferably between about 2 and about 3.5 mm, and more preferably between about 2.5 and about 3.0 mm. Openings 22 and 122, as illustrated, have a diameter of approximately 2.7 and approximately 2.9 mm, respectively.

Openings 22 are unobstructed and uncovered, as illustrated in FIG. 2. Seasoning mixture 18 does not fall through openings 22 when dispenser 10 is in a holes-down position, in the absence of shaking container 12 as illustrated in FIG. 6, because the anti-streaming agent prevents mixture 18 from streaming out of container 12. A single up-and-down vertical shake, however, dispenses from about 0.4 to about 0.6 grams of seasoning mixture 18. A single up-and-down shake dispenses seasoning mixture 18 in a generally circular area of about 6.5 square inches, as illustrated in FIG. 7. This area covers a food item F that is typically a hamburger, chicken or other meat or other patty.

Dispenser 10 may be made from any suitable materials. Preferably, dispenser 10 is rigid so that it cannot be deformed while being used. Preferably, container 12 is transparent so that the level of seasoning 18 can be easily determined, while other portions of dispenser 10 may be made from the same or different materials. Suitable materials include polycarbonate, polystyrene, polyethylene, glass, and stainless steel, for example.

The invention includes a method of seasoning. The method includes providing a dispenser. The dispenser has a primary chamber for containing a bulk quantity of the particulate seasoning and a secondary chamber. The primary chamber is in communication with the secondary chamber. The primary chamber may be located above and preferably directly above the secondary chamber. The secondary chamber is for containing a generally constant quantity of the particulate seasoning. The secondary chamber has at least one opening extending from the secondary chamber to the exterior of the container for dispensing the particulate seasoning from the secondary chamber in a relatively small and a relatively uniform discrete quantity compared to the quantity of seasoning contained in the secondary chamber in response to a single up-and-down shake of the container.

The dispenser may have a partitioning member for dividing the container into the primary and secondary chambers and passageways for permitting seasoning mixture to enter the secondary chamber from the primary chamber. The partitioning member is adapted to prevent the seasoning mixture received from the primary chamber from completely filling the secondary chamber.

The method includes storing a seasoning mixture in the primary chamber of the dispenser. The seasoning mixture has particles that can fit through the at least one opening. The method includes distributing the stored seasoning mixture into the lower or secondary chamber. The method includes vertically moving the container up and down directly over an item of food F to be seasoned as shown in FIG. 6. The up-and-down movement distributes the stored seasoning mixture into a secondary chamber and dispenses a controlled quantity of the mixture onto the food item from the secondary chamber. After seasoning, the dispenser is placed on a surface in a holes-down position, where it is maintained during non-seasoning.

The method of the invention may be used to season a plurality of food items as shown in FIG. 7. A plurality of food items to be seasoned may be placed on a surface in a row and column array. The method further includes an up and down vertical shake to dispense a quantity of the seasoning contained in dispenser 10 over a selected one of the food items F and thereafter horizontally moving dispenser 10 in a direct path to an adjacent unseasoned food item and then repeating the up and down vertical shake over the adjacent unseasoned food item and thereafter repeating the horizontally moving to a next unseasoned food item adjacent the last seasoned food item and then repeating the up and down vertical shake over the next unseasoned food item until a plurality of food items are seasoned with seasoning mixture. The single up-and-down movement dispenses a desired amount of seasoning mixture 18.

In one embodiment, the plurality of food items may include a plurality of hamburger patties or a plurality of chicken or other meat or other patties.

The method of the invention is very efficient as it allows a plurality of food items to be rapidly seasoned with the desired amount of seasoning. One efficiency is that there is no need to invert the dispenser. Moreover, inverting the dispenser or significant horizontal movement of the dispenser during dispensing is undesirable as it may cause a non-uniform amount of seasoning to be dispensed, increasing the likelihood that the food item will be underseasoned because seasoning will not land on the food item, and increasing the likelihood that the food item may in some areas not be seasoned at all. Thus, a substantially vertical movement is preferred.

While not wishing to be bound by theory, it is believed that there are two reasons why the dispenser of the invention works better than a prior art dispenser having a single chamber as will be discussed in the Examples. The first reason is discussed with reference to FIG. 10. The level of seasoning in chamber 14 may vary between a level 70 and minimum fill level line 38. Level 70 corresponds to the level of seasoning 18 in dispenser 10 when dispenser 10 is filled to refill line 42 and inverted to a holes-down position. The distances 74 and 76 between the top of upper chamber 14 and level 70 and minimum fill level line 38 vary significantly. It is believed that without partitioning member 30 and lower chamber 16, the velocity and resulting force of seasoning 18 impacting openings 22 and adjacent thereto could vary significantly as the level of seasoning varies between level 70 and minimum fill level line 38, resulting in uneven dispensing. In practice, users of dispenser 10 may continue to dispense seasoning 18 from dispenser 10 even when the fill level drops below minimum fill level line 38 because dispenser 10 appears to have sufficient seasoning further exacerbating the variation in the level of seasoning in dispenser 10. However, with partitioning member 30, the level of seasoning 72 in lower chamber 16 and the distance 78 between the top of lower chamber 16 and level 72 will not vary significantly even as the level of seasoning varies between minimum fill level line 38 and level 70. Thus, the conditions under which seasoning is dispensed from second chamber 16 will tend not to vary significantly, resulting in a more uniform dispense.

Also, it is believed that partitioning member 30, headspace 32, the shape of lower body portion 26, and passageways 28 work together to provide a uniform amount of seasoning, including when the level of seasoning in first chamber 14 decreases below apex 34 of partitioning member 30. Referring to FIG. 9, which illustrates the general movement of seasoning particles as they move within upper chamber 14 and within lower chamber 16 before exiting dispenser 10 through openings 20. To better illustrate this, the level of seasoning will be assumed to be below apex 34 of partitioning member 30.

As dispenser 10 is accelerated upwards, during the initial part of a vertical up-and-down shake to dispense a controlled amount of seasoning mixture 18, the seasoning will tend to be at rest relative to the dispenser. As dispenser 10 decelerates upwardly and begins to accelerate downwardly, seasoning mixture 18 located in lower body portion 26 of upper chamber 14 will tend to move upwards relative to dispenser 10 and towards the center axis of dispenser 10 because of sloping sidewall 44 of lower body 26 as shown by arrows 160A and 160B. As dispenser 10 decelerates downwards, seasoning will move downwards relative to dispenser 10 as shown by arrows 162A and 162B. The seasoning then hits partitioning member 30 and moves downward and towards sidewall 44 as shown by arrows 164A and 164B. Some of the seasoning will pass through passageways 28 into lower chamber 16 as shown by arrows 166A and 166B.

We will now discuss the flow of seasoning within lower chamber 16. As dispenser 10 is accelerated upwards, during the initial part of a vertical up-and-down shake to dispense a controlled amount of seasoning, the seasoning will tend to be at rest relative to the dispenser. As dispenser 10 decelerates upwards and begins to accelerate downwards, seasoning located in lower chamber 16 will have a tendency to move upwards relative to dispenser 10 and then upwards and towards the center axis of dispenser 10 because of partitioning member 30 as shown by arrows 168A and 168B, and 170A and 170B, respectively. As dispenser 10 decelerates downwards, seasoning will move downwards relative to dispenser 10 as shown by arrows 172A and 172B. Some of the seasoning will pass through openings 22 and be dispensed as shown by arrows 174A and 174B.

The net effect is that the level of seasoning in lower chamber 16 tends to be relatively uniform. Without partitioning member 30, when the level of seasoning is low, the seasoning level can vary significantly across the diameter of dispenser 10 because the up-and-down motion for dispensing seasoning is not perfectly vertical. In an extreme case, there may not be any seasoning in certain locations resulting in no seasoning being dispensed from a particular opening and the food item being inadequately seasoned in certain areas. Of course, a food worker seasoning food items would probably realize that the level of seasoning is too low before such an extreme case occurs. However, streaming can occur when the level of seasoning is too low over a particular opening resulting in the food item being overly seasoned in certain areas and as a whole. It has been found that food workers will often not refill a prior art dispenser even when the level of seasoning drops below the minimum fill line because the level of seasoning appears to be adequate.

### EXAMPLE

Testing was performed to compare the performance of dispenser 10 to a prior art dispenser. Dispenser 10 was tested with cover 20.

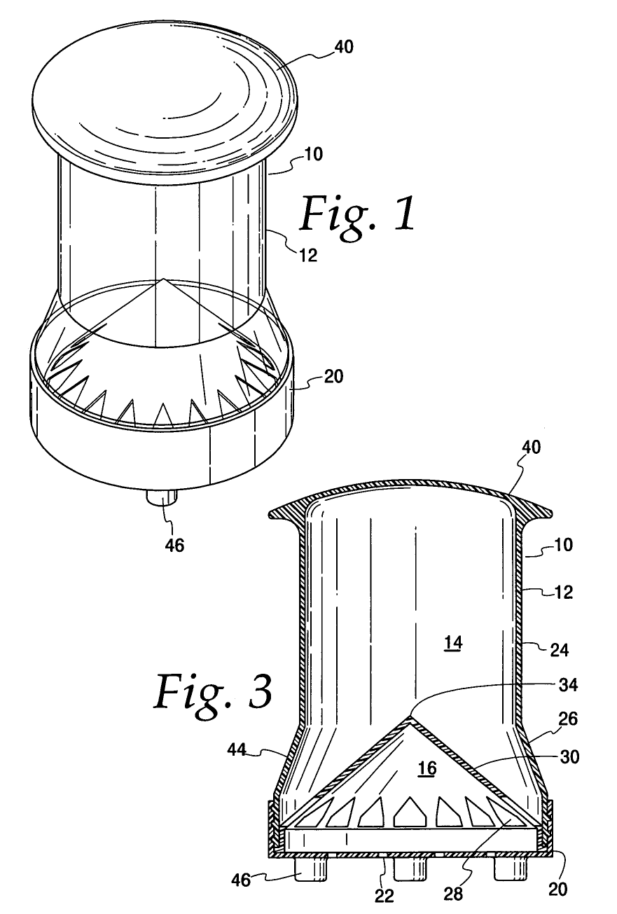

The prior art dispenser had the same container upper body, minimum fill line, and container lower body as dispenser 10 illustrated in FIG. 1. However, the prior art dispenser lacked second chamber 16 and partitioning member 30. The prior art dispenser also had a cover having 20 0.15″ diameter holes. The prior art dispenser was used in a fashion similar to that illustrated in FIGS. 6 and 7 to dispense a salt, pepper and oil seasoning mixture.

Both dispensers were filled to the same level, a level below the minimum fill line. Next, each dispenser was shaken as illustrated in FIGS. 6 and 7 six times and the total amount of seasoning dispensed was measured. The shaking and measuring was repeated about 100 times.

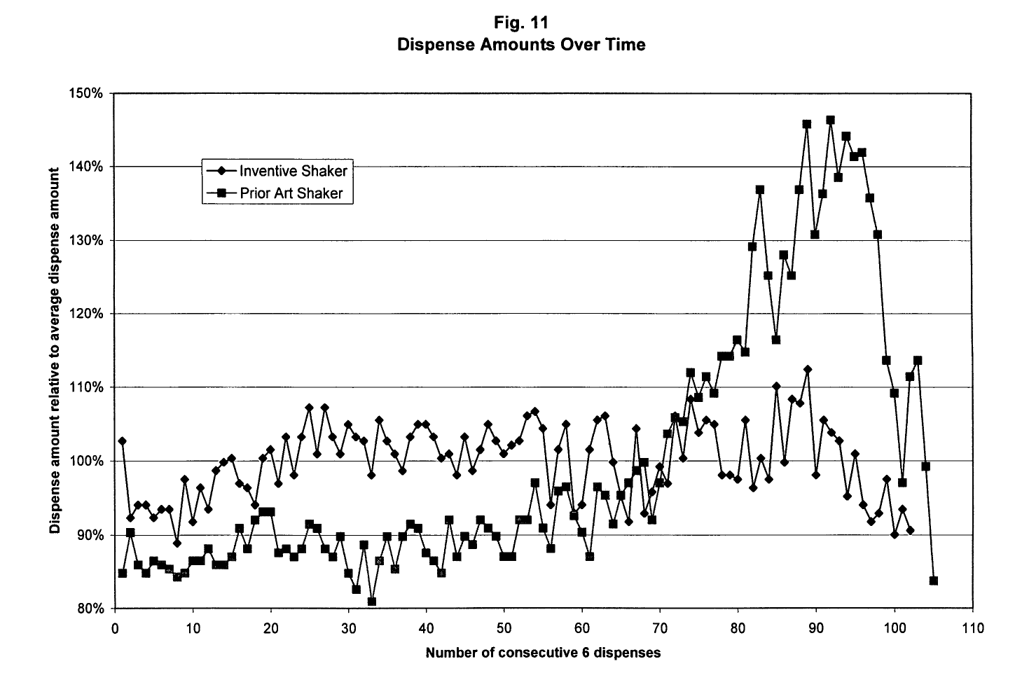

Representative results are shown in FIG. 11 and in Table 1 below. As can be seen in FIG. 11, after about 50 dispenses, the amount dispensed from the prior art dispenser begins to increase and the increase becomes marked after about 70 dispenses. The variation of the amount dispensed over 6 shakes also increases markedly. Because the measured amounts were for six shakes, FIG. 11 tends to smooth out the variability of the amount dispensed per shake. In comparison, no discernable trend upwards or downwards is seen for dispenser 10.

TABLE 1

| Amount Dispensed as % | | Prior Art |
|---|---|---|
| of average of 6 dispenses | Dispenser 10 | Dispenser |
| Minimum | 88.9% | 80.9% |
| Maximum | 112.4% | 146.3% |
| Median | 100.4% | 92.0% |
| Mean | 100% | 100% |
| Standard deviation of 6 dispenses | 5.0% | 17.7% |
| Standard deviation of single dispense | 12.4% | 43.4% |
| as % of average of a single dispense | | |

Table 1 shows that dispenser 10 has a substantially and significantly more uniform dispense amount than the prior art dispenser especially at low levels of seasoning. For example, the maximum amount of 6 dispenses for the prior art dispenser is 80.8% more than the minimum amount of 6 dispenses while the same overage is only 26.5% for dispenser 10. In addition, the standard deviation of 6 dispenses for dispenser 10 is less than one third of the prior art dispenser. Moreover, the standard deviation for a single dispense is 43.4% of the average of a single dispense. Thus dispenser 10 is a significant advance over the prior art.

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims.

We claim:

1. A seasoning shaker dispenser for containing and dispensing a quantity of a particulate seasoning comprising:
an upper chamber for containing a bulk quantity of the particulate seasoning;
a lower chamber in communication with the upper chamber for containing a generally constant quantity of the particulate seasoning and having at least one opening extending from the lower chamber to the exterior of the container for dispensing the particulate seasoning from the lower chamber in a relatively small quantity compared to the quantity of seasoning contained in the lower chamber in response to a single up-and-down shake of the container.

2. The seasoning shaker dispenser according to claim 1 further comprising a seasoning mixture in the container and comprising an anti-streaming agent and seasoning particles selected from the group consisting of salt, spices, herbs and mixtures thereof.

3. The seasoning shaker dispenser according to claim 2 wherein the opening is larger in cross-sectional dimension than the size of the seasoning particles, but not so large as to cause streaming.

4. The seasoning shaker dispenser according to claim 1 further comprising a partitioning member for dividing the container into the upper and lower chambers, the partitioning member adapted to prevent the seasoning mixture from filling the lower chamber.

5. A seasoning shaker dispenser for containing and dispensing a quantity of a particulate seasoning, comprising:
a container having a primary chamber and a secondary chamber, the primary chamber located above the secondary chamber and for containing a bulk quantity of the particulate seasoning, the secondary chamber having at least one opening for dispensing a relatively uniform discrete amount of the particulate seasoning from the secondary chamber of the container in response to a single up-and-down shake of the container; and
a partitioning member for dividing the container into the primary and secondary chambers and for permitting seasoning mixture to enter the secondary chamber from the primary chamber and being adapted to prevent the seasoning mixture received from the primary chamber from completely filling the secondary chamber.

6. The seasoning shaker dispenser according to claim 5 further comprising a seasoning mixture contained in the dispenser and comprising an anti-streaming agent and particles selected from the group of salt, spices, herbs and mixtures thereof contained in the primary chamber.

7. The seasoning shaker dispenser according to claim 5 wherein the opening is larger in cross-sectional dimension than two seasoning particles.

8. The seasoning shaker dispenser of claim 5 further comprising at least one passageway for permitting the particulate seasoning to enter the secondary chamber from the primary chamber and wherein the partitioning member converges at its top and restricts communication between the primary and secondary chambers.

9. The seasoning shaker dispenser of claim 8 wherein the partitioning member is substantially conical in shape.

10. The seasoning shaker dispenser of claim 8 wherein the passageway is sized and configured so that when sufficient particulate seasoning is in the primary chamber the seasoning mixture bridges over the passageway after the dispenser is vertically shaken up and down.

11. The seasoning shaker dispenser of claim 8 wherein the at least one passageway comprises a plurality of passageways passing through the partitioning member.

12. The seasoning shaker dispenser of claim 8 wherein the secondary chamber is sized to contain between 10 and 100 times the discrete amount.

13. The seasoning shaker dispenser of claim 12 wherein the primary chamber is sized to contain over 300 times the discrete amount.

14. The seasoning shaker dispenser of claim 8 wherein the at least one passageway comprises a plurality of openings generally uniformly contained in a generally circular array.

15. The seasoning shaker dispenser of claim 14 wherein the at least one passageway is located vertically above the circular array and proximate the periphery of the circular array.

16. The seasoning shaker dispenser of claim 14 further comprising an external support member disposed on the exterior of the dispenser adjacent the secondary chamber so that when the dispenser is placed on a flat surface in contact with the external support member the at least one opening does not contact the surface.

17. The seasoning shaker dispenser of claim 14 wherein a single up-and-down vertical shake dispenses from about 0.25 to about 0.6 grams of the seasoning mixture.

18. The seasoning shaker dispenser of claim 14 wherein a single up-and-down vertical shake dispenses the seasoning mixture in a generally circular area of about 6.5 square inches.

19. A method of seasoning a food item comprising:
providing a dispenser comprising:
an upper chamber for containing a bulk quantity of the particulate seasoning;
a lower chamber in communication with the upper chamber for containing a generally constant quantity of the particulate seasoning and having at least one opening extending from the lower chamber to the exterior of the container for dispensing the particulate seasoning from the lower chamber in a relatively small quantity compared to the quantity of seasoning contained in the lower chamber in response to a single up-and-down shake of the container;
storing a seasoning mixture in the dispenser; and
vertically moving the container up and down directly over an item of food to be seasoned to distribute the stored seasoning mixture into a dispensing chamber and to dispense a controlled quantity of the mixture onto the food item from the lower chamber.

20. A method of seasoning a food item comprising:
providing a dispenser comprising:
a container having a primary chamber and a secondary chamber, the primary chamber located above the secondary chamber and for containing a bulk quantity of the particulate seasoning, the secondary chamber having at least one opening for dispensing a relatively uniform discrete amount of the particulate seasoning from the secondary chamber of the container in response to a single up-and-down shake of the container; and
a partitioning member for dividing the container into the primary and secondary chambers and for permitting seasoning mixture to enter the secondary chamber from the primary chamber and being adapted to prevent the seasoning mixture received from the primary chamber from completely filling the secondary chamber;
storing in the primary chamber a seasoning mixture having particles that can fit through the at least one opening,
distributing the stored seasoning mixture into the secondary chamber; and
vertically moving the dispenser up and down directly over an item of food to dispense a controlled quantity of the seasoning mixture onto the food item from the secondary chamber, the quantity being substantially less than the amount of seasoning mixture in the secondary chamber.
